(19) United States
(12) Patent Application Publication
(10) Pub. No.: US 2008/0059500 A1
(43) Pub. Date: Mar. 6, 2008

(54) System and method for collaborative data sharing and analysis

(76) Inventor: Chad Symens, Canal Fulton, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/516,009

(22) Filed: Sep. 5, 2006

(51) Int. Cl. G06F 7/00

(52) U.S. Cl. 707/101

(57) ABSTRACT

A collaborative data sharing and analysis system comprises a primary database utilizing a plurality of tables, and a user client that provides an interface that displays a retail and supplier data perspective. The primary database utilizes a recursive load function to load data recursively from the database tables so that a hierarchical organization of the data is presented via the interface. Once the data has been loaded, the user interface allows a user to manipulate the stored data according to one or more permissions, thus allowing a retailer and a supplier to collaborate with each other in real-time.

### TECHNICAL FIELD

Generally, the present invention relates to a system for collaborative data sharing and analysis. Specifically, the present invention relates to a system for collaborative data sharing and analysis that provides a centralized primary database and a user-client interface that allows retailers and suppliers to analyze shared data. Particularly, the present invention relates to a system for collaborative data sharing and analysis that provides users with a data perspective which is generated from a database structure employing a recursive loading function.

### BACKGROUND

Retailers, and the suppliers that provide the products to the retailers, are constantly seeking current and accurate sales data so that future business strategies can be formulated. In a typical arrangement, the supplier first sells its goods to the retailer where they are then sold to consumers or other businesses. As those goods are sold, product activity data is generated by the retailer, which relates to the sales information of the particular goods, and may include such data as: point of sale (POS) data; inventory data; units sold; forecasted demand; and any other product-centric information. Once compiled, the product activity data is made available to the supplier on a daily or weekly basis for example. Often, however, the retailer may collect product activity data and aggregate it into a format or arrangement that is difficult or time consuming for the supplier to readily interpret and put into strategic use. For example, many retailers provide their generated product activity data in the form of an EDI, which is an initialism for electronic data interchange, or equivalent flat file. An exemplary flat data file does not provide the supplier with the granularity or level of detail needed to make strategic business plans, unless additional data mining is performed. However, the software analysis tools and training necessary for a supplier to perform its own data mining and analysis of the raw product activity data may be time and cost prohibitive. Thus, the supplier may choose to disregard the product activity data altogether in forming its future business plans.

Because of the close business relationship between retailers and suppliers it is often necessary for them to communicate or consult with each other regarding the sales performance of the various products sold by the supplier. However, this is often a problem in that communication and data dissemination may occur in many different forms that are difficult to anticipate. Unfortunately, because each retailer may choose to communicate its performance data with the supplier using a different mode, it can become challenging for the supplier to effectively organize, and make use of such data on a daily or weekly basis.

Therefore, there is a need for a collaborative data sharing and analysis system that allows the supplier and retailer to efficiently share product activity data. And, there is a need for a collaborative data sharing and analysis system that permits the supplier and retailer to create a data perspective to organize various product activity data. There is also a need for a collaborative data sharing and analysis system that permits the supplier and retailer to share data reports with each other in real-time.

### SUMMARY OF THE INVENTION

In light of the foregoing, it is a first aspect of the present invention to provide a system and method for collaborative data sharing and analysis.

Another aspect of the present invention is to provide a database comprising a reports table maintaining a reportID field, a files table maintaining a fileID field, a users table, a folders table maintaining a folderID field, wherein the folders table is self-referential, a parentgroups table maintaining a groupID field and a parent groupID field, a groups table, and a permissions table maintaining permissions associated with each folder in the folders table, wherein the folders table is related to the files table, the reports table, the users table, the groups table, and the permissions table by the folder ID field.

Yet another aspect of the present invention is to provide a method for organizing data retrieved from a database for presentation as a user interface for user interaction comprising loading a group associated with a user, wherein said user group has at least one parent subfolder and at least one child subfolder which are also loaded, loading a group root folder associated with the user group, and loading any user group subfolders contained therein, and loading a user root folder associated with the user, and loading any user subfolders contained therein.

Still another aspect of the present invention is to provide a computer-readable medium having computer-executable instructions for performing a method comprising creating a database structure comprising a reports table to store one or more reports, a files table to store one or more files, a users table to identify individual users, a folders table to identify where each the report and the file is located, wherein the folders table is self-referential, a parentgroups table, a groups table, and a permissions table, wherein the folders table is related to the files table, the reports table, the users table, the groups table, and the permissions table, and wherein the users table is related to the reports table, the files table, the folders table, and the permissions table, and wherein the groups table is related to the parentgroups table, the users table, and the permissions table, loading a user-client on a computer, the user-client providing an interactive interface to a user, executing a recursive load function to organize the folders and subfolders of the database in a hierarchical manner, the recursive load function also loading the contents of each folder, and displaying the hierarchically organized folders via the user client, such that the user of the user client is able to navigate the folders with an input device.

Yet another aspect of the present invention is to provide a database comprising a first table maintaining a first username field, the first table being self-referential, a second table maintaining a second username field, and first groupID field, a third table maintaining a second groupID field, wherein the first and the second tables are related to each other by the first and second username fields, and the second and third tables are related to each other by the first and second group ID fields.

### BRIEF DESCRIPTION OF THE DRAWINGS

This and other features and advantages of the present invention will become better understood with regard to the following description, appended claims, and accompanying drawings wherein:

FIG. 1 is a block diagram showing a high-level systems view of a collaborative data sharing and analysis system according to the present invention;

FIGS. 2-2G show a block diagram showing the relationships between tables of a database system utilized by the collaborative data sharing and analysis system;

FIG. 3 is a block diagram showing the operational steps taken by a recursive load software function that is used to load a data perspective generated by the system;

FIG. 4 is a screen view showing the retailer and supplier data perspectives displayed via a user interface provided by the collaborative data sharing and analysis system;

FIG. 5 is a screen view showing the user interface, and the hierarchical organizational structure provided by the collaborative data sharing and analysis system;

FIG. 6 is a screen view showing the user interface of the collaborative data sharing and analysis system where a user is dragging and dropping an item from the retailer data perspective of the interface to the supplier data perspective of the interface, and vice versa; and

FIG. 7 is a screen view showing the user interface of the collaborative data sharing and analysis system without an options section.

### BEST MODE FOR CARRYING OUT THE INVENTION

The following discussion makes reference to the terms retailer and supplier, thus for the purpose of clarity, the term “supplier” is defined as an entity that sells goods or products primarily to a retailer. A “retailer” is likewise defined as an entity (retail or wholesale) that purchases goods or products from a supplier, and in turn sells the goods or products to end consumers (individuals) or other business entities where they are put into use.

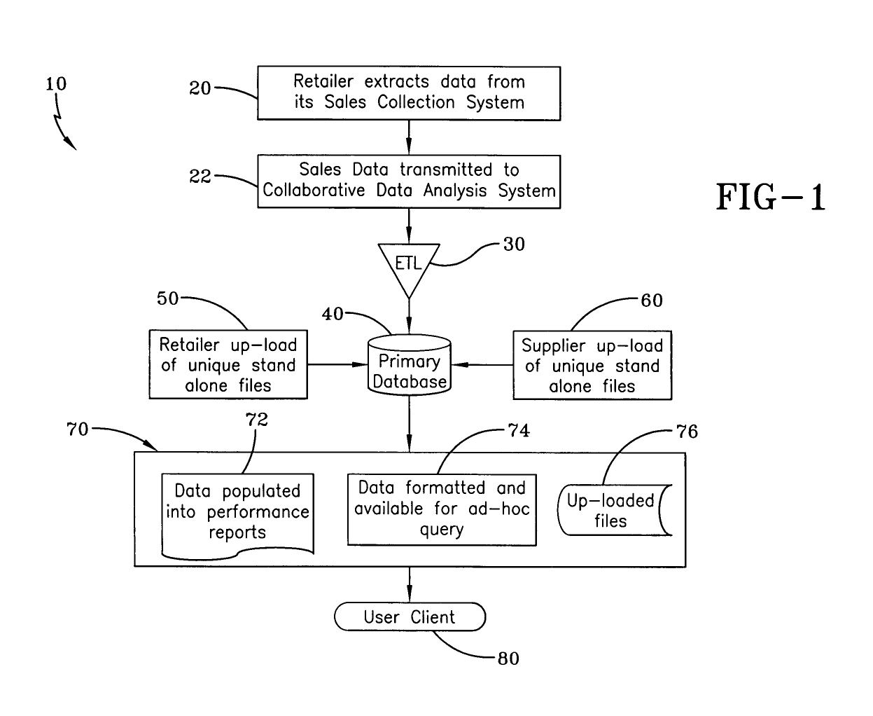

A collaborative sharing and data analysis system and related implementation procedure according to the concepts of the present invention is generally designated by the numeral 10 as shown in FIG. 1, of the drawings. The collaborative system 10 is initiated at step 20, wherein the retailer extracts raw product activity data from its sales data collection systems, sales data warehouse system, or similar sales data storage system. This raw product activity data may comprise various data including: forecast data, inventory data, promotions data, and point of sale data regarding one or more of the suppliers' products sold to end consumers by the retailer. As will be understood by the skilled artisan, this data may be collected from scanned bar code data, RF ID devices, manually entered data, or any comparable data input devices. Next, at step 22, the raw data is transmitted to an extraction, translation, and load (ETL) component 30 utilizing an electronic data interchange (EDI) or a secure file transfer protocol (SFTP), although any other data transmission system or network may be utilized. For example, product activity data may be transferred to the ETL 30 via a wireless network connection if desired. The ETL 30 generally comprises a software component that is operable on a computer system, such as a networked server, for example. Particularly, the ETL component 30 converts the raw product activity data from the various sources, and are organized into a structure based on the needs of the terms and understanding of the user. Additionally, the ETL component 30 converts data lookup tables into readable form, cleans the data so as to remove duplicates, and standardizes data fields so that data is accurate and organized for the user. Furthermore, because unacceptable or corrupt data can be prevented from entering the system 10, the operation of the ETL component 30 can be halted as well. This allows the unacceptable or corrupt data to be analyzed before being published to the business users, so that data misinterpretation and incorrect conclusions drawn therefrom can be avoided.

A primary database 40 may comprise database software executed on a suitable server computer and receives the output of the ETL 30. It is contemplated that the primary database 40 may be embodied by any suitable database software package such as sold under the trade names: Oracle, DB2, or Openbase, for example. For the user presentation, an On-Line Analytical Processing (OLAP) database is utilized, so as to provide optimal performance and flexibility. The OLAP database software supports multiple databases containing OLAP cubes. A cube comprises logical business structures, defined by dimensions and measures, which provides users a foundation for interactive data analysis. In addition to receiving the raw product activity data from the retailer, other data may be transmitted to the primary database 40. For example, both the retailer and the supplier may upload specific sales data, such as data files or reports, to the primary database 40 as indicated respectively at steps 50 and 60 so as to collaboratively share the data files and reports in a real-time manner. The primary database 40 is configured to have a relational structure that permits the sales data and any other data, such as a file or report, to be organized in a hierarchical manner.

A webserver, which is designated generally by the numeral 70, is configured to access and manipulate the shared data stored in the primary datasbase 40 in accordance with a recursive loading function to be discussed. In one aspect, the webserver 70 is a software component that is installed and executed on a server computer. The webserver 70 is configured to communicate with the primary database 40 using hypertext transmission protocol (HTTP), however any other suitable application level protocol may be used. The webserver 70 performs various functions including: populating data into preconfigured reports 72, formatting data in accordance with user defined ad-hoc queries 74, and providing the retailer or supplier with the option of uploading any desired data files 76. It is also contemplated that the webserver 70, may provide additional functionality beyond that identified above. A user-client 80, which may be the retailer, supplier, or other approved third party, accesses the webserver 70 via any suitable computer network connection, so as to allow the retail or supplier user to interact with the system 10 so as to perform a variety of functions to be discussed. The user-client 80 is a software component that is executed on a remote computer system that accesses the webserver 70 using any suitable application layer protocol, such as hyper-text transfer protocol (HTTP), and provides various data organization and data manipulation functions, which will be described later.

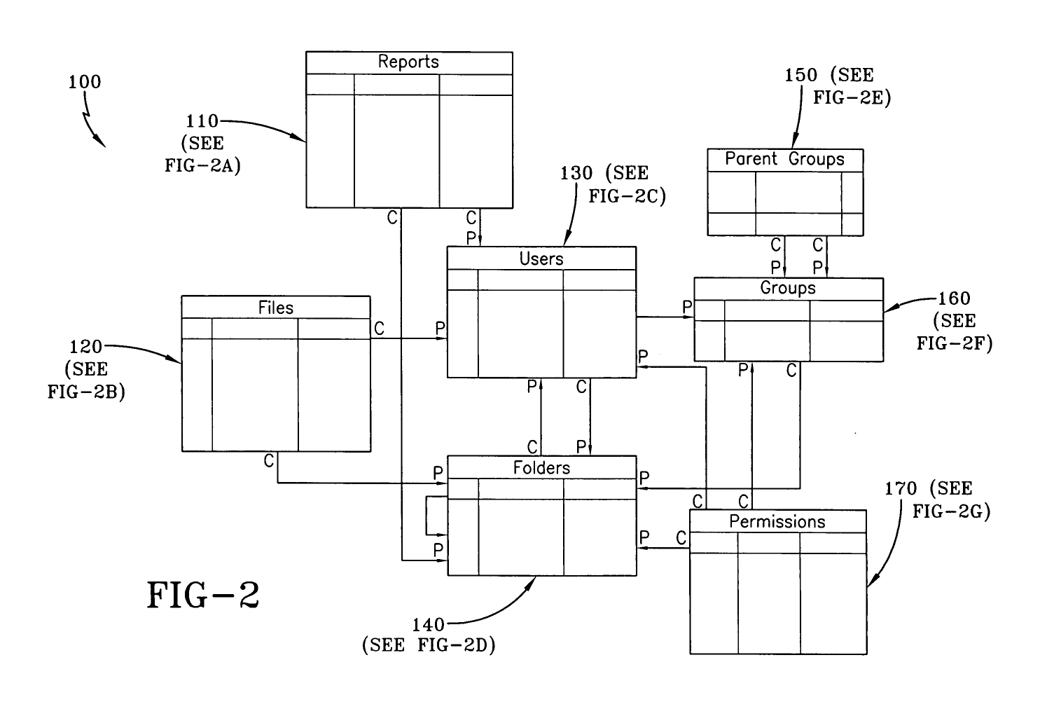

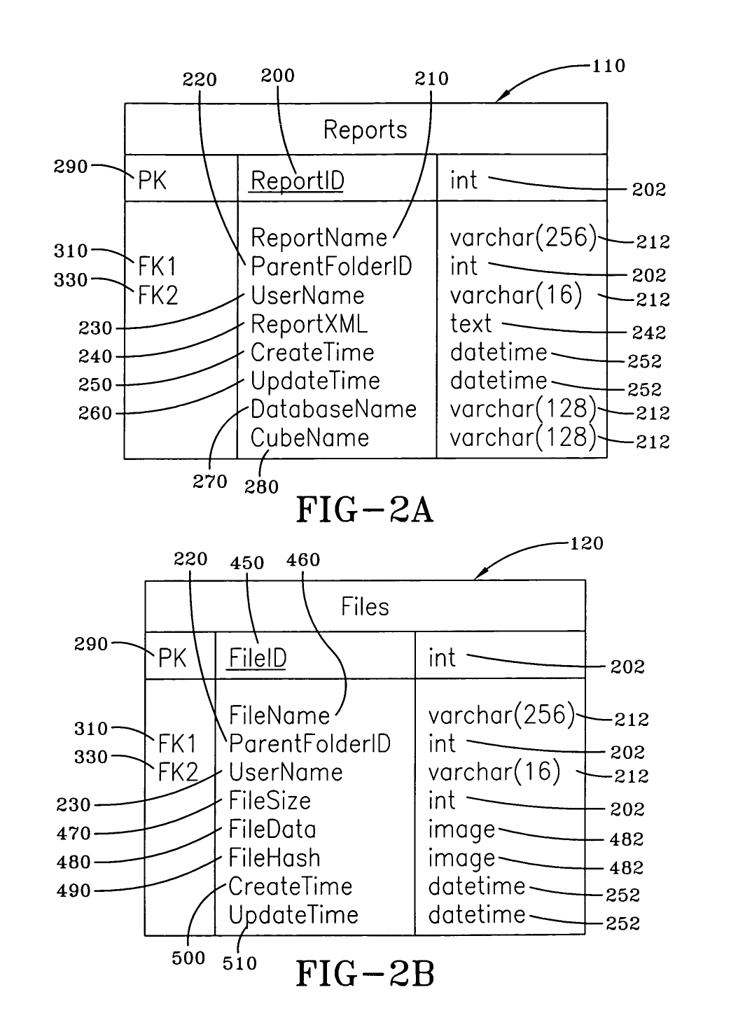

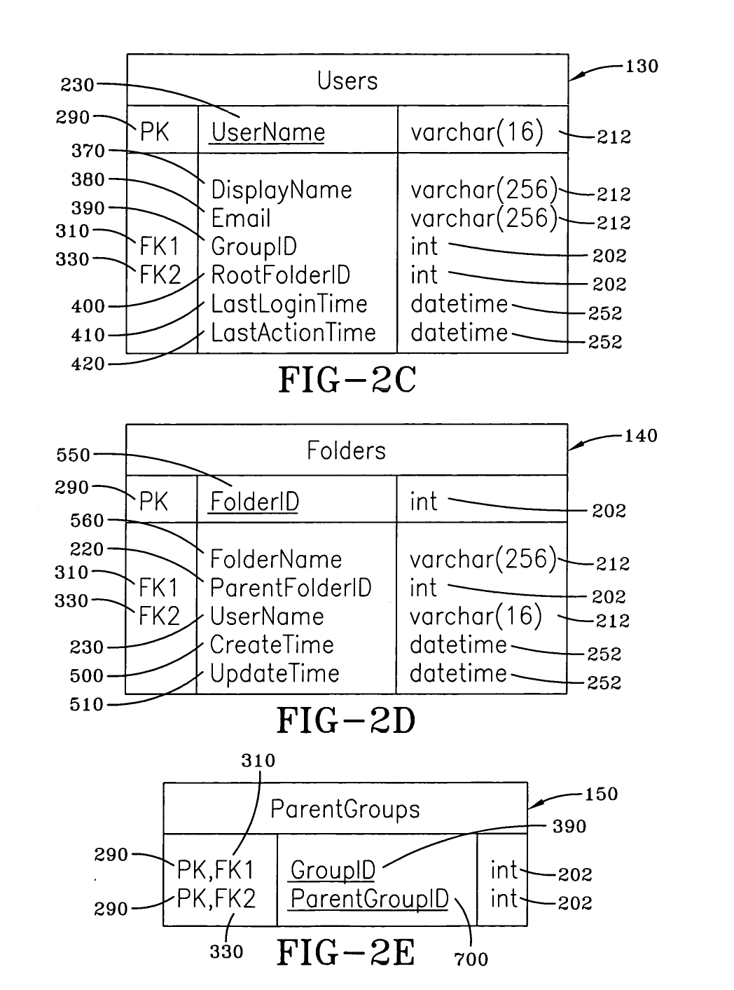

Continuing, FIG. 2 shows a diagram of a flat database structure 100 that is maintained by the primary database 40, wherein FIGS. 2A-2G show components of the structure. The database structure 100 comprises a plurality of tables that are related to each other by a variety of primary and foreign keys. Briefly, a primary key is a unique value that is used to uniquely identify each individual data record (row) that is maintained in each table of the database structure 100. A foreign key is a value used by one or more child tables that exactly matches the value of a particular primary key used by a parent table to which a relationship is sought. That is, the foreign key of the child table is used to reference the primary key in the parent table, thus allowing the data in the parent and child tables to be joined or associated.

The tables of the database structure 100 include: a reports table 110, a files table 120, a users table 130, a folders table 140, a parentgroups table 150, a groups table 160, and a permissions table 170. Each of the tables 110-170 maintained by the primary database 40, contain various fields and associated data types. The fields (center column) describe the data that is to be stored as a data element within each of the fields of the primary database 40, while the data type (right column) defines the physical parameters of the data elements. In each table, some of the fields have primary and/or foreign keys (left column) associated therewith.

Specifically, the reports table 110 comprises: a reportID field 200 having an integer data type 202; a reportname field 210 having a variable character (varchar) data type 212; a parentfolderID field 220 of the integer data type 202; a usename field 230 of the variable character (varchar) data type 212; a reportXML field 240 having a text data type 242; a createtime field 250 having a datetime data type 252; an updatetime field 260 of the datetime data type 252; a databasename field 270 of the variable character (varchar) data type 212; and a cubename field 280 of the variable (varchar) data type 212. The reportID field 200 of the reports table 110 is set as the primary key (PK) 290, the parentfolderID is set as a foreign key 1 (FK1) 310, and the usemame field 230 is set as a foreign key 2 (FK2) 330.

Briefly, the integer data type 202 permits only integer data to be stored in the corresponding field, and the variable character data type 212 permits only alphanumeric characters to be stored into the associated field. The size of each respective variable character type filed for all of the tables is provided in the parentheses associated therewith. Additionally, the text data type field 242 allows only text characters to be stored in the corresponding field. Finally, the datetime data type 252 permits only data relating to the date and time to be stored in the associated field.

The report ID field 200 of the reports table 110 is provided to store a unique integer value used to identify each individual report stored in the primary database 40. Next, the reportname field 210 stores an alphanumeric name or identifier to allow a user of the system 10 to easily identify each stored report. The parentfolderID field 220 allows a unique integer value to be associated therein so as to uniquely identify each folder in which a particular report is stored by the primary database 40. The username field 230 allows a user name of a user of the system 10 to be associated with a particular folder. Additionally, the reportXML field 240 allows various text based sales reports to be stored. Thus, the reportXML field 240 stores the reports generated by the retailer or supplier that are to be displayed and shared using the system 10. The createtime and updatetime fields 250, 260 respectively store the date and time in which a particular report was created, and the date and time in which a particular report was modified. Furthermore, the various reports, identified by the reports table 110, are a graphical representation of data contained in an analysis cube. Specifically, the cubename field 280 stores the name of the OLAP cube, which acts as a reference to the cube whose data is displayed by the associated report. Thus, with the cubename reference, the report can properly identify the specific cube, including the specific business dimensions and measures that the report is to display.

Continuing, the users table 130 includes: the usemame field 230 of a variable character data type 212; a displayname field 370 of a variable character data type 212; an email field 380 of a variable character data type 212; a groupID field 390 of an integer data type 202; a rootfolderID field 400 of an integer data type 202; a lastlogintime field 410 of a datetime data type 252; and a lastactiontime field 420 of a datetime data type 252. The username field 350, the group ID field 390, and the rootfolderID field 400 of the reports table 110 are respectively set as the primary key (PK) 290, the foreign key 1 (FK1) 310, and the foreign key 2 (FK2) 330 of the users table 130.

The username field 230 of the users table 130 allows the full name of an authorized user of the system 10 to be stored. The displayname field 370 also allows an alphanumeric identifier to be stored in the primary database 40. Specifically, the displayname field 370 may comprise a shortened version of the user's full name that is stored in the usemame field 230, or any other suitable nickname or unique identifier. The email field 380 allows a user's email address to be stored. The groupID field 390 is an integer value that identifies a particular group of associated or related users. For example, the company to which one or more retail users belongs may be identified by a unique groupID field 390 value. The rootfolderID field 400 stores an integer value that identifies the specific root folder that is associated with each individual user of the system 10 that is identified by their username which is stored in the username field 230. The next field in the users table 130 is the lastlogintime field 410, which stores the date and time in which a user last accessed the system 10. Finally, the lastactiontime field 410 allows the date and time in which a user executed or initiated the last function maintained by the system 10.

The files table 120 stores data pertaining to each file that is created in the primary database 40. Specifically, the files table 120 comprises a FileID field 450 having an integer data type 202, wherein the FileID field serves as the primary key (PK) 290 of the files table 120. Additionally, the files table 120 includes: a filename field 460 of a variable character data type 212; the parentfolderID 220 of an integer data type 202; the usemame field 230 of a variable character data type 212; a filesize field 470 of an integer data type 202; a filedata field 480 of an image data type 482; a filehash field 490 of an image data type 482; a createtime field 500 having a datetime data type 252; and a updatetime field 510 of a datetime data type 252. The parentfolderID field 220 and the username field 230 serve as respective first (FK1) and second (FK2) foreign keys 310 and 330 for the files table 120. With regard to the data types of the files folder 120, specifically, the image data type 482 permits file images to be stored in the associated folder.

The FileID field 450 allows a unique integer value to be stored so as to uniquely identify each of the files stored in the primary database 40. Next, the filename field 460 allows the user of the system 10 to store a unique alphanumeric name that is associated with each created data file so that it can be readily identified by each user of the system 10. The parentfolderID field 220 allows for an identification code to be stored, which identifies the particular parent folder in which a particular file resides. The usemame field 230 allows a unique user name relating to the user of the system of who created the particular file to be stored and associated with a particular stored file. The filesize field 470 allows the size of a particular file to be stored. The file data field 480 allows an individual data file itself to be stored in the primary database 40. The filehash field 490 maintains a checksum for data transmission verification, which may be computed using a hashing mechanism such a MD5 or SHA1. The createtime and updatetime fields 250,260 respectively allow the date and time in which a particular file was created or updated to be stored.

The folders table 140 stores data regarding each folder that is created by a user of the system 10. Briefly, the folders table 140 comprises a folder ID field 550, which serves as the primary key (PK) 290 of the folders table 140. In addition, to the folder ID field 550, the folders table 140 comprises: a foldername field 560 having a variable character data type 212; a parentfolderID field 220 having an integer data type 202; a username field 350 having a variable character data type 212; the createtime field 500 having a datetime data type 252; and the updatetime field 510 having a datetime data type 252. Furthermore, the parentfolderID field 220 and the usemame field 350 are respectively identified as the first (FK1) and second (FK2) foreign keys 310,330 for the folders table 140.

The folders table 140 is configured with a self-referential or recursive relationship with itself as identified by arrow 570. This recursive relationship maintained by the folders table 140 allows the folders table 140 to access itself using the FolderID field 550 and the ParentFolderID field 220, so as to identify the parent and any sub or child folder in which a file or report may be stored. This allows data in the reports table 110 and the files table 120 to be stored in a hierarchy of folders, which is a primary feature of the system 10.

The folderID field 550 allows a unique integer value to be assigned to each created folder so that each folder can be identified in the data base system 100. Next, the foldername field 560 allows an alphanumeric name to be assigned to the folder so that a user of the system 10 can readily identify any particular folder stored in the primary database 40. The parentfolderID field 220 allows an integer value to be stored so as to identify the parent folder in which a file or other child folder may be stored. The username field 230, as previously discussed, associates the user who created a folder with the folder itself, while the createtime field 500 and the updatetime field 510 respectively store the date and time in which a particular file was created and modified.

To ensure the security of the data stored in the database 40, the permissions table 170 defines permissions for either users or groups for a specified folder. If a user is marked as the “owner” of a folder, report, or file, they are permitted full access regardless of their permissions for the folder (i.e. containing folder) containing such folder, report, or file. Permissions entries for all folders within the user's data perspective are loaded when the system 10 is initiated, and can be modified by the user-client 80 if the user has the appropriate permissions. In addition, data security is employed at both the webserver 70 and the user-client 80.

The permissions table 170 is provided to track the restrictions that may be imposed on certain actions or functions that a user of the system 10 is permitted to initiate via the user interface, that is to be discussed. The permissions table 170 comprises: the folderID field 550 having an integer data type 202; the usemame field 350 of the variable character (varchar) data type 212; the groupID field 390 of the integer data type 202; a cancreate field 570 of a bit data type 572; a canview field 580 of a bit data type 572; and a canedit field 590 of a bit data type 572. The folderID field 550 comprises the same data as the folders table 140, serves as the second foreign key (FK2) 330 of the permissions table 170. Moreover, the UserName field 230 stores the same data as that of the folders table 140. The GroupID field 390 serves as the third foreign key (FK3) 568 of the permissions table 170, and allows an integer value to be stored to identify the particular group to which a particular permission defined by the cancreate, candelet, canview, and canedit fields 570-600.

The cancreate, the candelete, the canview, and the canedit fields 570-600 allow a status bit 572 (a binary 0 or 1) to be stored therein, and each of the fields 570-600 are associated with various groups, folders, and files. Thus, access to the creation, deletion, viewing and editing of folders, files, and reports stored in the primary database 40 can be controlled, so that unauthorized users cannot alter the data or the organization of the data stored in the primary database 40. Specifically, if a binary one is stored in the cancreate field 570, the user of the system 10 is permitted to create a group or a folder. Similarly, when the status bit of the candelete field 580 is set to a one, the user of the system 10 may delete an individual group folder stored in the groups and folders table 160, 202. Furthermore, if the canview or the canedit status bit 590 is set to a one, the user is permitted to respectively view or edit a particular file or report. Correspondingly, if a binary zero is stored in the cancreate field 570, the can delete filed 580, the canview field 590, or the can edit field 600, the user is prohibited from invoking the actions previously discussed. It is also contemplated that the system 10 can be configured such that a binary zero status bit stored in the cancreate field 570, the candelete field 580, the canview field 590, or the canedit field permits such actions to me made by a particular user, while a binary one status bit prohibits a user from invoking such actions.

The groups table 160 serves to identify the organization, company, or institution to which each user of the system 10 is affiliated. The groups table 160 comprises the groupID field 390 that serves as the primary key (PK) 290 of the groups table 160, and is of an integer data type 202. In addition, the groups table 160 comprises a groupname field 660 of a variable character (varchar) data type 212, and the rootfolderID field 400 of an integer data type 202. Moreover, the rootfolderID field 400 is identified as the first foreign key (FK1) 310 of the groups table 160.

The groupID field 390 allows a unique integer value to be stored so as to identify each group created and stored in the primary database 40. The groupname field 660 allows a unique name to be associated with each created group. The rootfolderID 400 allows a unique integer to be associated with each root folder that is created within a particular group in the primary database 40.

The ParentGroups table 150 comprises the groupID field 390 of an integer data type 202, and a parentgroupID field 700 of an integer data type 202. The groupID field 390 serves as the primary key (PK) 290 and the first foreign key (FK1) 310 of the parentgroups table 150. Moreover, the parent group field 700 is established as the primary key (PK) 290, and the second foreign key (FK2) 330 of the parentgroups table 150.

Specifically, the groupID field 390 allows a unique integer to identify each group created and stored in the primary database 40. The ParentGroupID field 700 stores a unique integer that identifies each parent group created in the primary database 40.

In addition to the particular tables 110-170 set forth, the database structure 100 is defined by the particular relationships established between each of the tables 110-170 by the primary (PK) 290 and foreign keys (FK1, FK2, FK3) 310,330,568. These relationships are further evidenced in the C-P leadlines between the tables, wherein C designates the “child” in the relationship and the P designates the “parent.” Briefly, the users table 130 utilizes the usemame field 230 as a primary key (PK) 290, and is related to the reports table 110 via the usemame field 230 which has associated FK2 330 therewith, to the files table 120 via the usemame field 230 (FK2), to the folders table 140 via the usemame field 230 (FK2), and the permissions table 170 via the username field 230 which has FK1 310 associated therewith.

The folders table 140, which uses the folderID 550 field as the primary key (PK), is related to the reports table 110 via the parentfolderID field 220 which is associated with FK1 310, to the files table 120 via the parentfolderID 220 (FK1 310), to the users table 130 via the rootfolderID field 400 (FK2 330), to the groups table 160 via the rootfolderID field 400 (FK1 310), and to the permissions table 170 via the folderID field (FK2 330).

Finally, the groups table 160 utilizes the groupID field 390 as a primary key (PK 290), so as to relate the groups table 160 to the parentgroups table 150 via the groupID field 390 (FK1 310), to the users table 130 via the groupID field 390 (FK1 310), and to the permissions table 170 via the groupID field 390 (FK3 568).

Briefly, the folders table 140 defines the fundamental organization of all data stored in the primary database 40. The data elements within the reports table and the files table 110,120 are required to be in a single folder. In addition, all the data elements found in the folders table 140 are self-referential, in that a particular folder (parent) can contain folders (child) as well. Thus, each element of the users table 130 contains reference to exactly one folder identified in the folder table 140, which is referred to as the user's root folder. The root folder serves as the foundation for the user's personal storage area within the system 10. Moreover, each user has a reference to exactly one element in the groups table 160. The groups table 160 defines the organization the user is directly affiliated with, for example the company that employs the user of the system 10. Each data element in the groups table 160 can also contain zero or more parent groups, which are represented by entries in the parentgroups table 150.

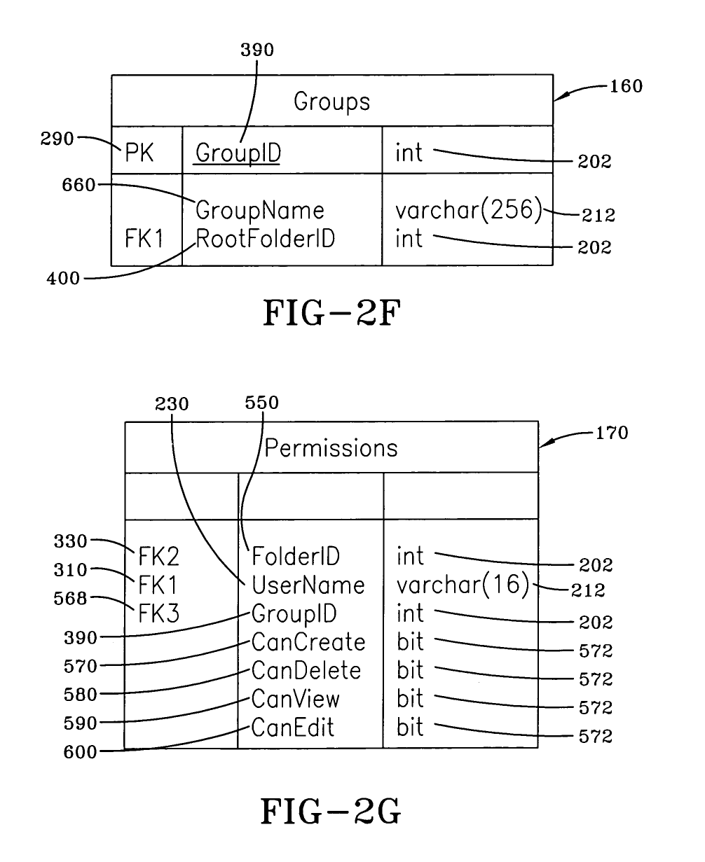

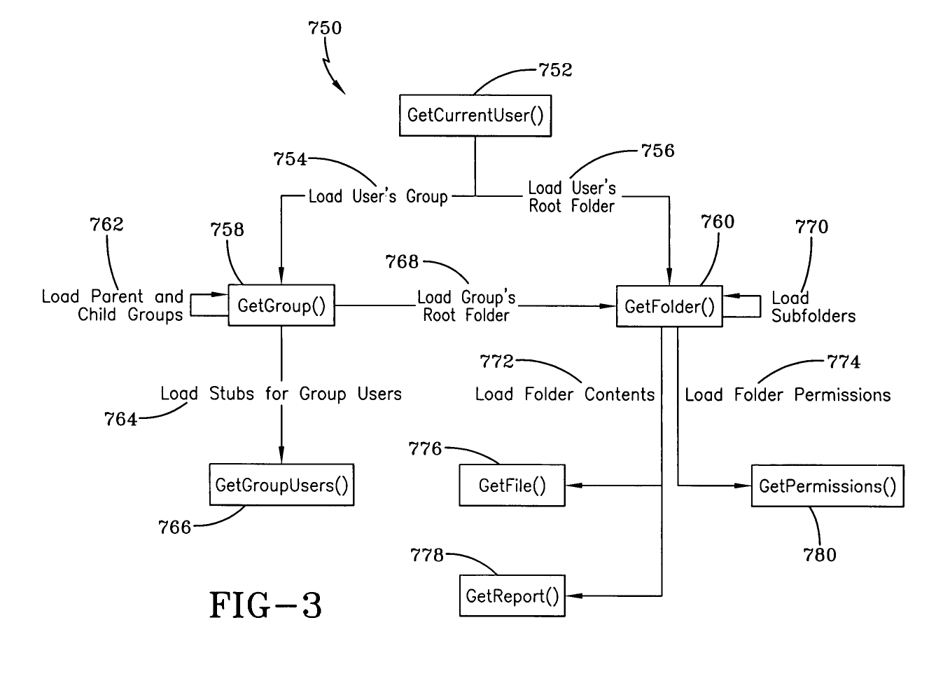

In order to present the data stored at the primary database 40 in an organized and logical manner via the user-client 80, a recursive load function or component, designated generally by the numeral 750 shown in FIG. 3, is provided by the collaborative data analysis system 10, which accesses the database structure 100 previously discussed. The recursive component 750 is generally embodied as a software component using any suitable low or high-level programming language, and is executed by the server computer maintaining the primary database 40. The recursive component 750 is responsible for taking the flat data that is stored by the database structure 100, and organizes it into a hierarchical form that embodies the supplier and the retailers data perspectives shown via the user-client 80 that is to be discussed.

The operation of the recursive load component 750 is initiated when the user-client 80 has been executed or launched. Once the user-client 80 has been launched, the user-client 80 makes a function call to the webserver 70 requesting the data perspective for the currently-authenticated user. This function call may be employed using any application layer protocol, such as HTTP for example. The webserver 70 responds by loading the data perspective in accordance with the recursive load methodology embodied by the recursive load component 750 shown in FIG. 3.

After the function call is received from the user-client 80, the recursive load component 750 begins operation at step 752, where a call to a GetCurrentUser( ) function is initiated. The GetCurrentUser( ) function invokes a load user's group process 754 and a load user's root folder process 756. The load user's group process 754 and the load user's root folder process 756 is carried out by a GetGroup( ) function 758 and a GetFolder( ) function 760 respectively. The GetGroup( ) function 758 initiates a self-referential or recursive Load Parent/Child Groups process 762, which results in multiple function calls of the GetGroup( ) function 758 being made until all of the parent and child groups are loaded from the parent groups and groups tables 150,160 are loaded. In addition, the GetGroup( ) function 758 initiates a Load Stubs for Group Users process 764, which is carried out by the GetGroupUsers( ) function 766. The Load stubs for group users 764 process obtains the stored data from the groups and users database tables 160,130, as indicated by the call GetGroupUsers( ) 766. Furthermore, the GetGroup( ) function 758 also initiates a load group's root folder process 768, which is carried out by the GetFolder( ) function 760, which accesses the folders table 140. The GetFolder( ) function 760 is self-referential as indicated at 770, and as such, continues to call itself until the user's root folder, and all subfolders associated with the current user have been loaded, according to the folders table 140. The GetFolder( ) function 760 also acquires the files and reports from the reports and files table 110,120 of the user's root folder, and subfolders by invoking a load folder contents 772 and load folder permission process 774. The load folder contents process 772 is completed by a GetFile( ) function 776 and a GetReport( ) function 778 that acquires the particular files and reports contained in the current user's root and subfolders, and the user's group folder, according to the folders table 140. The load folder permission process 744 is carried out by the GetPermissions( ) function 780, and causes the permissions associated with the particular user and group folders to be loaded.

After the recursive load component 750 has finished initiating the various function calls, the data embodying the retailer and supplier data perspectives are transmitted from the webserver 70 to the user-client 80 as a serialized object graph representing the hierarchal structure of the data elements, and a set of flat dictionary objects stored in the tables 110-170 of the database structure 100. For example, the binary serialization may transmit the object graph data as an encoded base-64 data stream. It should be appreciated that the object graph is a tightly-linked relationship between the elements in a user's data perspective to be discussed. That is, the object graph is evidence of the hierarchical relationship between elements in the database structure 100, while the flat dictionary objects are used for lookups within this hierarchy. Additionally, a Soap Message Transmission Optimization Mechanism (MTOM) may also be used to optimize all binary data transmissions between the user-client 80 and the webserver 70. This transmission scheme allows near-O(1) lookup of data elements by ID number from the single flat dictionary stored in the tables 110-170 of the database structure 100. In addition, circular references within the object graph are retained, allowing the entire structure to be manipulated programmatically by the user-client 80, exactly how it was maintained by the primary database 40, without complex reconstruction.

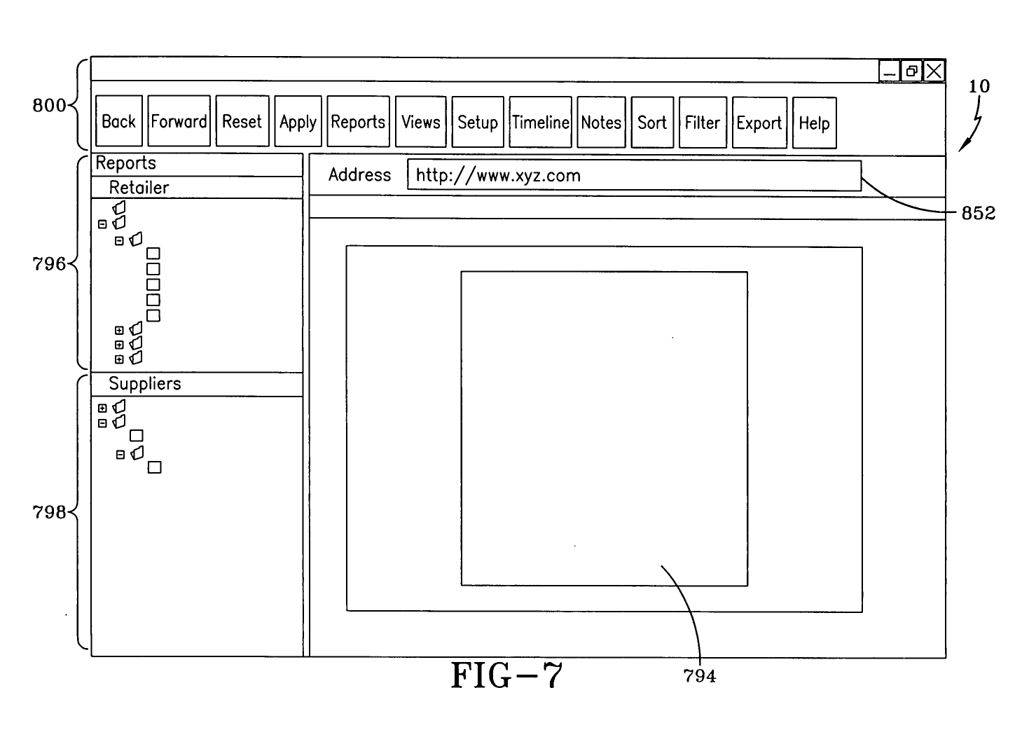

After the data from the primary database 40 has been called in accordance with the recursive load component 750, the retailer and supplier data perspectives are formed and displayed via an interface 790, as shown in FIGS. 4-7 of the drawings. The interface 790 may be a graphical user interface (GUI) that graphically displays the hierarchically organized data perspective that comprises various books, and folders. The interface 790 also allows the user to interact with various options, groups, folders, files, and reports that are displayed via the interface 790, using an input device, such as a computer mouse. Specifically, the interface 790 comprises an options section 792, a display section 794 (shown in FIG. 7), a retailer section 796, a supplier section 798, and a functions section 800. The options section 792 of the interface 790 relates to the sharing of data between the retailer section 796 and the supplier section 798. Specifically, the options section 792 comprises: an open cube option 802; a create new book option 804; a create new folder option 806, a create new page option 808; a save option 810; and a publish file to server option 812.

The open cube option 802 presents the default analysis view for a user-specified analysis cube, while the create new book option 804 allows a user to create a book in which other items such as various files, folders and reports may be stored. The create new folder option 806 allows users to create other folders to be discussed below. The create new page option 808 allows user to create new data reports to be discussed below. The save option 810 saves the current analysis view as a new report, while the publish file to server option 812 allows a user to send a static file, such as a MICROSOFT WORD document, EXCEL spreadsheet, PDF document, or the like to the server 70, so that it can be shared with other users of the system 10. Alternatively, it should also be appreciated that the create new page option 808, and the save option 810 may be provided by a save report option 814. The save report option 814 saves the current analysis view as a new report, or replaces the contents of the existing report with the current view.

The functions section 800 of the interface 790 comprises several user selectable functions, which include: a file function 832; a tools function 834; a help function 836; a back function 838; a forward function 840; a reset function 842; an apply function 844; a books function 846; a views function 848; and a setup function 850.

The file function 832 allows a user to create, open, or save various files or reports that are stored in the retailer or supplier sections 796,798. Continuing, the tools function 834 is a general-purpose collection of shortcuts provided by the interface 790. For example, the tools function may allow a user to modify a particular report or file if the particular user has the proper permissions, or other options may be provided to display an assistant window for the analysis view, or to customize the user preferences. The help function 836 allows the user to gain access to various tutorials that illustrate to the user how to carryout or execute the various functions or procedures provided by the system 10. The back function 838, the forward function 840, and the reset function 842 are for use with the display section 794, which is shown in FIG. 7. The display section 794 displays the various reports, and data files that may be stored and selected in the retailer or supplier sections 796,798. In addition, the display section 794 can serve as a web browser, and may load web pages identified by a URL address (uniform resources locator) that may be entered into an address field 852. As such, when a webpage, report, or file is loaded into the display section 794, the back and forward functions 838,840 allow a user to navigate through consecutive reports, files, web pages, or the like as desired. The reset function 842 allows the display section 794 to be reloaded so as to update the contents displayed thereby. In addition, the reset function 842 will display the default analysis view for the current cube, as if the user had selected the open cube option for that cube. Next, the apply function 844 allows the user to re-execute any changes made to the report, and executes the new analysis query, and loads the new results from the server 70. The books function 846 allows the user to create a new book in either the retailer or the supplier section 796,798 of the interface 790. Continuing, the views function 848 allows the user of the system 10 to change the format in which the sales performance data or the various reports are displayed via the display section 794. For example, the display section 794 may display the data stored in the retailer or supplier sections 796,798 as various types of charts such as an area chart, a bar chart, a histogram, a line chart, a pie chart, a point chart, and a performance map for example. Finally, the setup function 850 allows the user to change the data that is displayed in the current analysis view. In particular, the changes that the user can apply depend on the current analysis cube.

The retailer section 796 and the supplier section 798 comprise the primary areas of the interface 790, where the user of the system is able to manipulate and share data. In particular, the retailer section 796 comprises the retailer data perspective 860, which comprises a hierarchical directory structure that at its highest level comprises a universal books folder 862, a shared retailer books folder 864, and a my books folder 866. Specifically, the universal books folder 862 provides an area in which data is arranged, and is available to both retail users and supplier users of the system 10. This allows the suppliers and the retailers to collaborate with each other in a real-time manner. The shared retailer books folder 864 provides an area where the retailers are able to store books, folders, reports, and files for sharing with other retail users only. That is, access to data located in the shared retailer books folder 864 is restricted to only retail users. The my books folder 866 provides a folder that is restricted to a specific user of the system 10, and prevents other users from gaining access to its contents. Thus, each user of the system 10 has a my books folder 866 that allows him or her to store and organize various data in a desired manner, without any disturbance from other users of the system 10.

It should also be appreciated that the functionality provided by the options section 792 as shown in FIGS. 4-6 may be incorporated into the functions section 800, as shown in FIG. 7. In other words, the menu structure and functions provided by the functions section 800 may be modified to include the functionality provided by the various options 802-814 of the options section 792.

The supplier section 798 comprises a supplier data perspective 870, which is an area that contains supplier data associated with each individual supplier that is utilizing the collaborative data analysis system 10. Thus, data pertaining to one or more suppliers may be presented in the suppliers section 798 of the interface 790. The suppliers section 798 comprises at its highest level one or more shared supplier books folders 872. Within each of the supplier book folders 872 may reside one or more folders, reports, and files, which are organized in a manner to be discussed below.

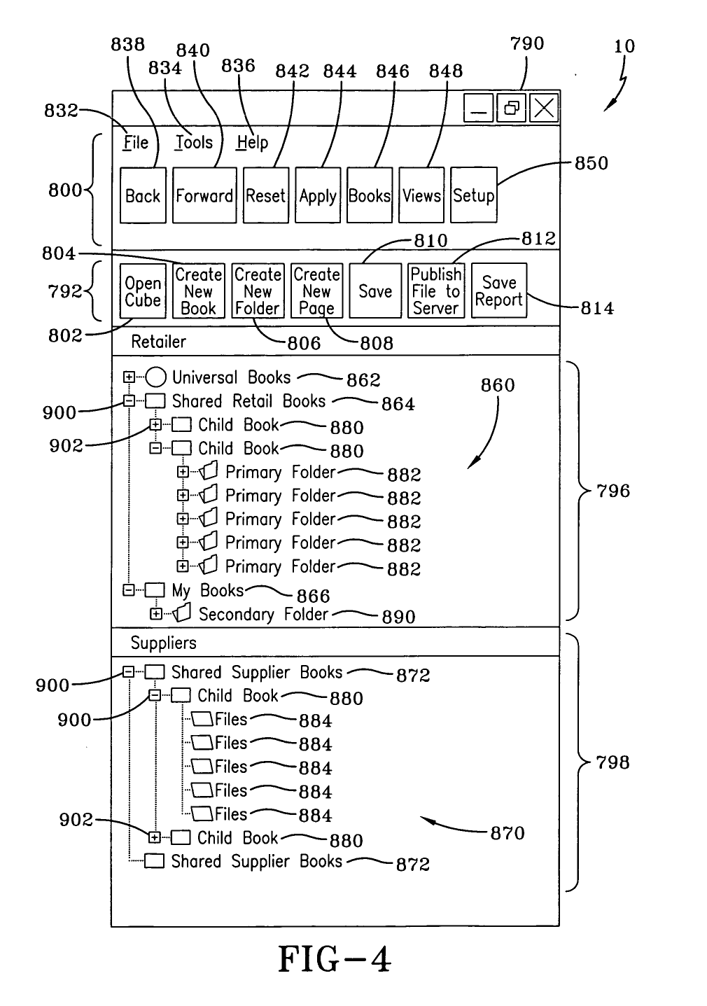

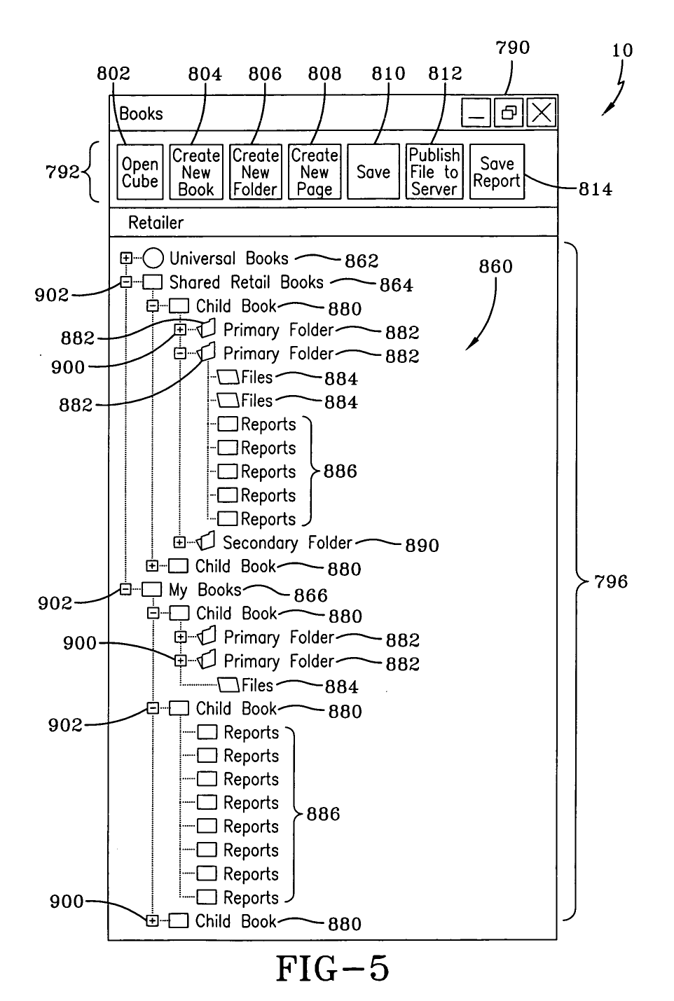

During the initial use of the system 10, the retail user is presented with the retail data perspective 860 via the interface 790, which as a starting point includes the universal book folder 862, the shared retail book folder 864, and the my books folder 866. Similarly, the supplier user is presented with the supplier data perspective 870 that includes one or more shared supplier books 872. As such, because all of the contents of the retail and supplier data perspectives 860,870 are configured to adhere to a parent/child hierarchy, whereby the universal book folder 862, the shared retail books folder 864, and the my books folder 866, and the shared supplier books folder 872 are referred to as the parent folders. As shown more clearly in FIG. 5, within each parent book folder 862, 864, 866, 872 a child book folder 880 may be created. Further, within each child book folder 880, a primary folder 882, a file 884 and/or a report 886 may be stored. And within any primary folder 882, any number of secondary folders 890, files 884 and/or a report 886 may be created or stored. To create a new child book 880 or a new primary of secondary folder 882,890 the retail or supplier user would respectively select the create book option 804 or the new folder option 806 from the options section of the interface 790.

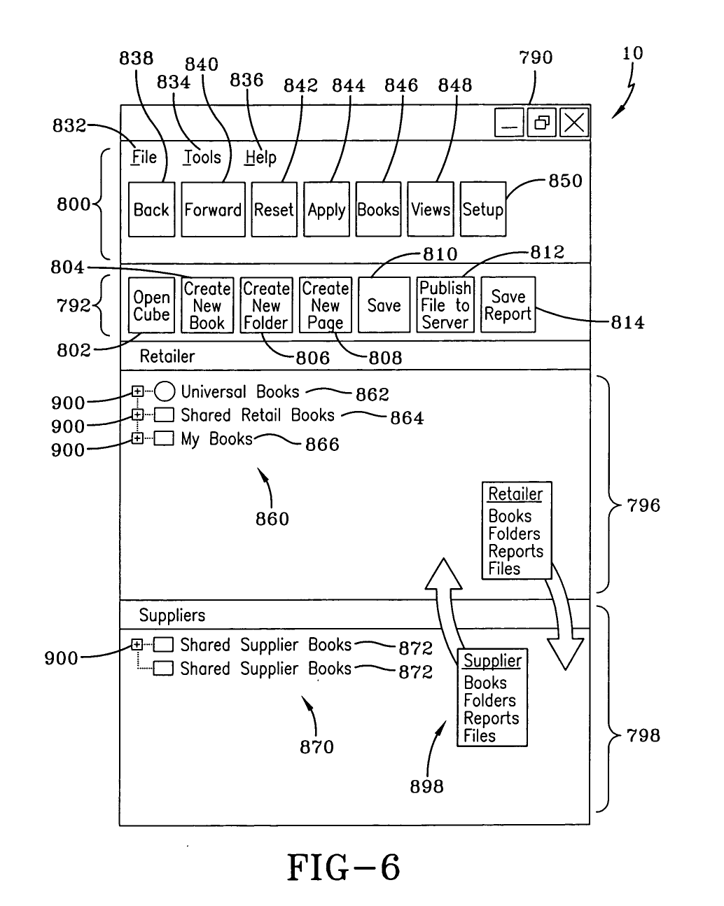

Users are permitted to move or copy various books, folders, reports and files between the various books and folders of the retailer and supplier data sections 796,798 using the interface 790, as shown in FIG. 6, by a drag and drop procedure 898, according to certain permission restrictions that may be placed on a particular book or folder. The drag and drop procedure may be implemented using a standard input device such as a computer mouse, for example. Permissions control the ability in which a user is able to perform certain actions within the interface 790. Specifically, permissions can be set to restrict the ability of a particular user to add, delete, rename, or move an individual book, folder, file, or report.

In addition, the level of detail displayed by the retailer data perspective and the supplier data perspective 870 may be expanded or contracted by selecting a respective “+” expansion identifier 900 or a “−” contraction identifier 902. By selecting the “+” identifier 900, any parent book 862, 864, 866, 872, or child book 880, or primary/secondary folder 882,890 may be opened to show its contents in a hierarchical or directory tree arrangement. Similarly, by selecting the “−” contraction identifier 902, for any parent book 862, 864, 866, 872, or child book 880, or primary or secondary folder 882,890 may be collapsed within the selected book or folder to reduce the level of detail shown. Thus, by expanding or contracting the various folders, the user of the system 10 is able to view the parent-child hierarchy of the contents of various books, folders that may be contained within each of the various folders.

To facilitate the collaboration between the retailers and suppliers, the various books, folders, reports and files located in the retailer section 796 or supplier section 798 of the interface 790 can be shared. For example, folders, reports, and files stored in the supplier section 798, can be dragged and dropped into the retailer section 796, using a computer input device, such as a computer mouse. Likewise, reports, files, primary and secondary folders stored in the retailer section 796 can be dragged and dropped into the various groups and folders of the supplier section 798.

It will, therefore, be appreciated that one advantage of one or more embodiments of the present invention is that a system for collaborative data sharing and analysis is able to present a retailer and a supplier with a hierarchical data perspective. Still another advantage of the present invention is that a recursive load function is utilized, which allows the data stored in a primary database to be accessed and manipulated via a remote user client. Yet another advantage of the present invention is that a database structure utilizes a self-referential, such that a hierarchy of storage folders can be created to organize various sales data and reports. Another advantage of the present invention is that remotely located retailers and suppliers can use an interface to share and analyze sales in real-time. These advantages enable retailers and suppliers to, individually and collaboratively, share sales, inventory and other related data. This exchange of information further enhances the retailer/supplier relationship so as to minimize costs and provide a competitive advantage.

Although the present invention has been described in considerable detail with reference to certain embodiments, other embodiments are possible. Therefore, the spirit and scope of the appended claims should not be limited to the description of the embodiments contained herein.

What is claimed is:

1. A database comprising:
a reports table maintaining a reportID field;
a files table maintaining a fileID field;
a users table;
a folders table maintaining a folderID field, wherein said folders table is self-referential;
a parentgroups table maintaining a groupID field and a parent groupID field;
a groups table; and
a permissions table maintaining permissions associated with each said folder in said folders table;
wherein said folders table is related to said files table, said reports table, said users table, said groups table, and said permissions table by said folder ID field.

2. The database of claim 1, wherein said users table maintains a username field and is related to said reports table, said files table, said folders table, said permissions table by said username field.

3. The database of claim 2, wherein said groups table also maintains said groupID field and is related to said parentgroups table, said users table, and said permissions table by said groupID field.

4. A method for organizing data retrieved from a database for presentation as a user interface for user interaction comprising:
loading a group associated with a user, wherein said user group has at least one parent subfolder and at least one child subfolder which are also loaded;
loading a group root folder associated with said user group, and loading any user group subfolders contained therein; and
loading a user root folder associated with the user, and loading any user group subfolders contained therein.

5. The method of claim 4 further comprising:
loading the contents of said group root folder and said user group subfolders.

6. The method of claim 5, wherein said contents comprises at least one report and a file.

7. The method of claim 4 further comprising:
loading the contents of said user root folder and said user group subfolders.

8. The method of claim 7, wherein said contents comprises at least one report and a file.

9. The method of claim 4 further comprising:
loading permissions associated with said group root folder and said user group subfolders.

10. The method of claim 4 further comprising:
loading permissions associated with said user root folder and said user group subfolders.

11. The method of claim 4 further comprising:
displaying said group root folder and said user group subfolders hierarchically via an interface.

12. The method of claim 4 further comprising:
displaying said user root folder and said user group subfolders hierarchically via an interface.

13. The method of claim 4, wherein at said first loading step, said parent and child subfolders are loaded recursively using the same software function.

14. The method of claim 4, wherein at said second loading step, said user group subfolders are loaded recursively using the same software function.

15. The method of claim 4, wherein at said third loading step, said user group subfolders are loaded recursively using the same software function.

16. A computer-readable medium having computer-executable instructions for performing a method comprising:
creating a database structure comprising:
a reports table to store one or more reports;
a files table to store one or more files;
a users table to identify individual users;
a folders table to identify where each said report and said file is located, wherein said folders table is self-referential;
a parentgroups table;
a groups table; and
a permissions table, wherein said folders table is related to said files table, said reports table, said users table, said groups table, and said permissions table, and wherein said users table is related to said reports table, said files table, said folders table, and said permissions table, and wherein said groups table is related to said parentgroups table, said users table, and said permissions table;
loading a user-client on a computer, said-user client providing an interactive interface to a user;
executing a recursive load function to organize the folders and subfolders of said database in a hierarchical manner, said recursive load function also loading the contents of each said folder; and
displaying said hierarchically organized folders via said user client, such that the user of said user client is able to navigate said folders with an input device.

17. The recitation of claim 16, further comprising:
limiting access to the folders according to one or more preferences associated with said folders stored in said permissions table.

18. A database comprising:
a first table maintaining a first username field, said first table being self-referential;
a second table maintaining a second username field, and first groupID field;
a third table maintaining a second groupID field;
wherein said first and said second tables are related to each other by said first and second username fields, and said second and third tables are related to each other by said first and second group ID fields.
